(19) United States
(12) Patent Application Publication
(10) Pub. No.: US 2006/0236057 A1
(43) Pub. Date: Oct. 19, 2006

(54) Memory access method with delayed write control signal and data processing apparatus

(76) Inventors: Alessio Beato, Pescara (IT); Lorenzo Di Gregorio, Pescara (IT)

Correspondence Address: JENKINS, WILSON, TAYLOR & HUNT, P. A., 3100 TOWER BLVD, SUITE 1200, DURHAM, NC, 27707, US

(21) Appl. No.: 10/963,257

(22) Filed: Oct. 12, 2004

(30) Foreign Application Priority Data
Oct. 28, 2003 (DE) 10350281.5

(51) Int. Cl. G06F 13/00

(52) U.S. Cl. 711/167

(57) ABSTRACT

The invention provides a data processing apparatus having a data input unit (108) for inputting data, at least one processor unit (107) for carrying out data processing steps (201, 201a, 201b) for the input data, at least one memory unit (402) for storing processed data, the data being able to be written to and read from the memory unit (402) on the basis of a write control signal (101) and a read control signal (102), and a data output unit (109) for outputting stored data, the write control signal (101) being able to be prescribed independently of the timing of the read control signal (102).

The present invention relates to data processing apparatuses in which data from memory units are read, are processed in processor units and are then stored back at the same or different storage locations in the memory units.

The present invention relates in particular to a data processing apparatus having a data input unit for inputting data, at least one processor unit for carrying out data processing steps for the input data, at least one memory unit for storing processed data, the data being able to be written to and read from the memory unit on the basis of a write control signal and a read control signal, and a data output unit for outputting stored data.

FIG. 1 shows a flow diagram containing signal profiles which arise during a conventional method for data storage and data reading. As FIG. 1 shows, a reference signal provided is a clock signal 100 which provides defined reference times 104a, 104b.

In the flow diagram shown in FIG. 1, the reference times are the rising clock edges of the clock signal 100, but the reference times 104a, 104b used may also be the falling clock edges of the clock signal 100 and, furthermore, both the rising and the falling clock edges of the clock signal 100. For the clock signal 100, a read/write control signal 100a is shown which prompts a data processing apparatus to execute a read/write mode.

A reference symbol 103 denotes a memory access signal which needs to be provided when a memory unit in the data processing apparatus is to be accessed and when data are to be written to the memory unit.

The signals in FIG. 1, i.e. the clock signal 100, the read/write control signal 100a and the memory access signal 103 are shown as a function of a time axis 105. Showing the signals in question as a function of time makes it clear that conventional methods for data storage may encounter situations in which data processing or data processing steps is/are carried out while a read control signal is already present for these data.

Disadvantageously, conventional methods have a fixed link between the timing of write control signals and that of read control signals, which means that, as FIG. 1 shows, a write control signal for storing data in line with a memory access signal 103 is provided too early. This may be caused by virtue of execution steps (data processing steps) requiring a plurality of clock cycles of the clock signal 100 such that memory access is not expected until after a plurality of clock cycles.

FIG. 2 shows an example of data processing in a data processing apparatus where delayed memory access in the form of a read control signal is required. The block diagram in FIG. 2 is split into a processor unit 107 and a memory unit 402.

In this example, two data processing steps 201a and 201b are carried out in the processor unit 107. To this end, a data input unit 200 is used to supply an input signal 203. As shown by the arrows in FIG. 2, the second data processing step 201b is dependent on the first data processing step 201a. Disadvantageously, conventional methods do not allow a plurality of clock cycles to be allocated to a single memory access operation. In order to carry out the data processing steps 201a and 201b in line with FIG. 2, however, a plurality of clock cycles per memory access operation are required when account is taken of the fact that one clock cycle corresponds to one execution step 201a or 201b.

FIG. 2 shows that two memory access steps 202a and 202b are provided in the memory unit 402. In this example, a memory access step 202a or 202b has a length of two clock cycles in line with two data processing steps 201a, 201b in the processor unit 107. With such an architecture, all read/write instructions need to have an “interlock” distance of at least 1.

Nevertheless, many instructions can complete the calculation in the data processing step 201b and their result may be required in the subsequent memory instruction. To observe the “interlock” distance of 0 between two successive instructions, it is necessary to execute a write instruction after memory access has already begun.

FIGS. 3(a) and 3(b) show further examples which reveal the need to provide a longer time period for data generation than for address generation. FIG. 3(a) shows the sequence of a data processing step 201 and of a memory access step 202, with a sequential succession of steps being provided for data processing and for memory access.

The need for an additional clock cycle can be seen in FIG. 3(b). In this case, two data processing steps 201a, 201b are arranged in series, with a memory access step 202 being arranged in parallel with the second data processing step 201b. When data processing has been carried out in the second data processing step 201b, it is therefore too late to start memory access in the memory access step 202.

Disadvantageously, conventional data processing methods require a read/write control signal 100a to be provided one clock cycle in advance, which means that it cannot be calculated during a second data processing step 201b shown with reference to FIG. 2.

Obviously, a write control signal can be provided only when it has been calculated. However, it may be necessary for such calculation also to be performed in the second data processing step 201b.

FIG. 4 shows a further block diagram, which comprises not only a data processing step 201 and a memory access step 202 but also a command decoding step 204 and a register access step 205. It should be pointed out that the command decoding step 204 and the register access step 205 can be combined so that they belong to a single stage.

In the command decoding step 204, control signals are output which are used to carry out data processing steps and memory access steps. The register access step 205 provides values from the register for addressing or for execution.

It is thus an object of the present invention to provide a data processing apparatus in which more than one clock cycle can be allocated to a single memory access operation.

The invention achieves this object by means of a data processing apparatus having the features of patent claim 1.

The object is also achieved by a method which is specified in patent claim 17.

Further refinements of the invention can be found in the subclaims.

A fundamental concept of the invention is for the write control signals and read control signals used in connection with a memory access operation to be prescribed independently of one another's timing.

In particular, the invention provides an implementation within a microprocessor pipeline structure. Preferably, there is no command which both reads and stores data, which means that there is provision for data reading to be independent of data storage.

The inventive data processing apparatus essentially has:

a) a data input unit for inputting data;

b) at least one processor unit for carrying out data processing steps for the input data;

c) at least one memory unit for storing processed data, the data being able to be written to and read from the memory unit on the basis of a write control signal and a read control signal; and

d) a data output unit for outputting stored data,

where the write control signal can be prescribed independently of the timing of the read control signal.

In addition, the inventive method for processing data essentially has the following steps:

a) data are input using a data input unit;

b) data processing steps are carried out for the input data using at least one processor unit;

c) the processed data are stored in at least one memory unit, the data being able to be written to and read from the memory unit on the basis of a write control signal and a read control signal; and

d) the stored data are output using a data output unit,

where the write control signal and the read control signal are prescribed independently of one another's timing.

The subclaims contain advantageous developments and improvements of the respective subject matter of the invention.

In line with one preferred development of the present invention, the write control signal and the read control signal are provided on the basis of the timing of a clock signal which is supplied to the data processing apparatus. Advantageously, reference times corresponding to rising and/or falling clock edges are derived from the clock signal.

In line with a further preferred development of the present invention, the data processing steps carried out in the at least one processor unit for the input data comprise mathematical operations.

In line with yet a further preferred development of the present invention, the at least one memory unit is provided for storing processed data in a memory access unit which provides either a read/write control signal having a fixed coupling between the timing of the write control signal and that of the read control signal or a write control signal which is delayed in comparison with the read control signal.

In line with yet a further preferred development of the present invention, the data processing apparatus contains a register addressing unit which supplies read/write addresses to the memory access unit. Preferably, the data processing apparatus also contains a short instruction unit which supplies short instruction signals to the memory access unit. In addition, it is expedient that a read control unit is provided which supplies read instruction signals to the memory access unit. Preferably, the data processing apparatus has a register write control unit which supplies register write instruction signals to the memory access unit.

In addition, a write control unit is provided which supplies write instruction signals to the memory access unit arranged in the data processing apparatus.

In line with yet a further preferred development of the present invention, the memory access unit also has a read/write selection unit which can select write data, memory write addresses and/or memory read addresses.

In line with yet a further preferred development of the present invention, the memory access unit also has a write storage register which provides buffer storage of write data, memory write addresses and of a register status.

In line with yet a further preferred development of the present invention, the memory access unit also has a random logic unit which performs the options of no access, read access, write access or combined read and write access for memory access.

In line with yet a further preferred development of the present invention, the memory access unit also has a memory access type unit which outputs a memory access type signal on the basis of at least one short instruction signal, at least one read instruction signal and/or at least one write instruction signal.

In line with yet a further preferred development of the present invention, the memory access unit also has a response detection unit which outputs a response signal.

In line with yet a further preferred development of the present invention, the memory access unit also has an allocation unit which supplies a chip select signal to the memory unit.

In line with yet a further preferred development of the present invention, the memory access unit also has a combinational logic unit which outputs a read access output signal on the basis of the response signal supplied by the response detection unit.

Exemplary embodiments of the invention are shown in the drawings and are explained in more detail in the description below.

### IN THE DRAWINGS

FIG. 1 shows a timing diagram for a conventional data processing method;

FIG. 2 shows an example of data processing with two data processing steps and two memory access steps to explain the problem on which the invention is based;

FIG. 3 shows a further block diagram with data processing steps and memory access steps to explain the problem on which the invention is based;

FIG. 4 shows a further block diagram with a command decoding step, a register access step, a data processing step and a memory access step to explain the problem on which the invention is based;

FIG. 5 shows a timing diagram for a data processing method based on a preferred exemplary embodiment of the present invention;

FIG. 6 shows a memory access unit with an illustration of the supplied signals and of the memory access unit output signal which is output;

FIG. 7 shows the detail of a memory access unit with input units and output units and an explanation of the corresponding signals;

FIG. 8 shows a block diagram which illustrates the design of a memory access unit and the associated signals in detail;

FIG. 9 shows a read/write selection unit which is contained in the memory access unit, and corresponding input and output signals;

FIG. 10 shows a memory access type unit and a table to illustrate combinational logic for the corresponding signals and generation of a memory access type signal;

FIG. 11 shows the design of a write storage register in the memory access unit with a status register, an address register and a data register;

FIG. 12 shows a random logic unit which is contained in the memory access unit, with corresponding input and output signals;

FIG. 13 shows a response detection unit and a combinational logic unit which are contained in the memory access unit, with corresponding input and output signals; and

FIG. 14 shows a memory unit for storing processed data.

In the figures, identical reference symbols denote components or steps which are the same or have the same function.

FIG. 5 shows a flow diagram for a data processing method based on a preferred exemplary embodiment of the present invention. A reference symbol 105 denotes a time axis (t) with which the corresponding time profiles of the individual signals are associated.

A reference signal prescribed for the data processing apparatus is a clock signal 100 which has specified reference times 104a, 104b. Such reference times 104a, 104b may be rising and/or falling clock edges of the clock signal 100.

It should be pointed out that signals other than a clock signal 100 may be provided as a reference signal, which the average person skilled in the art will know. A fundamental aspect is the allocation of signals controlling a read mode and a write mode to a memory access signal 103.

As FIG. 5 shows, one preferred exemplary embodiment of the present invention allows the write control signal 101 and the read control signal 102 to be prescribed independently of one another.

In the text below, a preferred exemplary embodiment of the present invention is used to give a detailed description of a memory access unit 301 which uses the inventive method for data processing, in which the write control signal 101 can be prescribed independently of the timing of the read control signal 102.

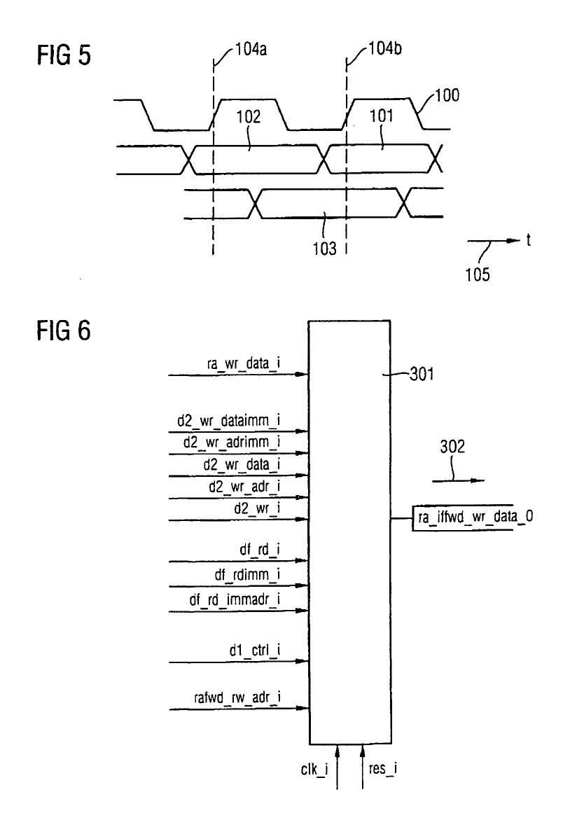

FIG. 6 shows the memory access unit 301 with the essential input signals required for operating the memory access unit 301 and with the memory access unit output signal 302 which is provided at the output of the data processing apparatus.

It should be pointed out that FIG. 6 illustrates the interfaces of a memory access unit 301 which is used in a microprocessor. However, the invention is not limited to memory access units in microprocessors, but rather may be used in any data processing apparatus.

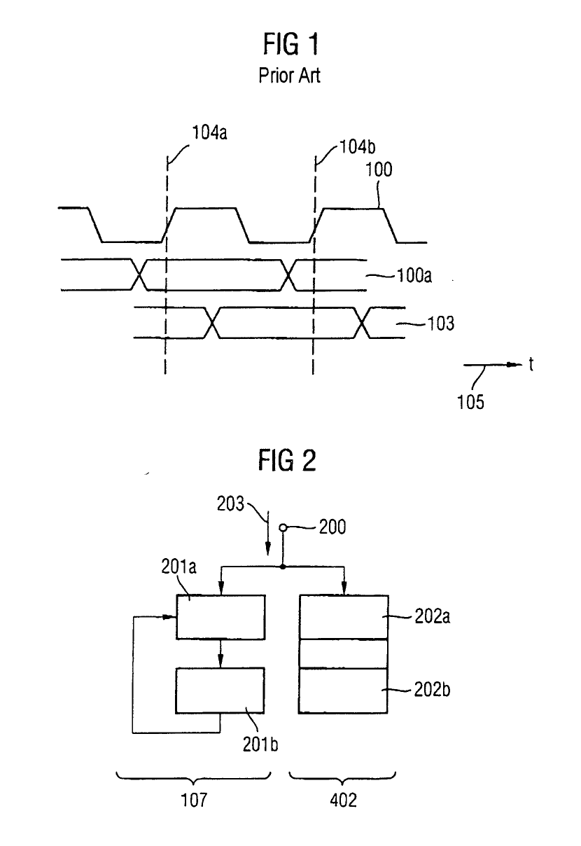

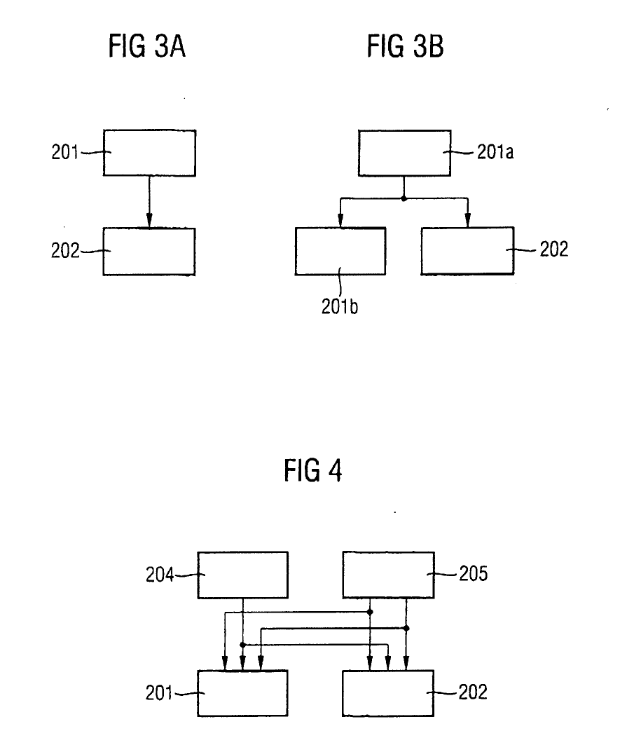

In particular, this embodiment shows that at least two types of memory access are available: the conventional memory access with a single read/write control signal 100a (described above with reference to FIG. 1) which provides a fixed coupling between the timing of a write control signal and that of a read control signal, and a read control signal which is provided after a delay in comparison with a write control signal, as shown with reference to FIG. 5, such a delay being provided in line with a preferred exemplary embodiment of the present invention. Table 1 below summarizes the corresponding input signals which are supplied to the memory access unit 301 using the corresponding explanations.

TABLE 1

| | |
|---|---|
| INPUT SIGNALS: | |
| Rafwd_rw_adr_i | Indirect register read (early) or |
| | write (late) address |
| d1_ctrl_i | (Early) operation to be performed |
| | by the memory access unit 301 |
| | (memory access using a short |
| | instruction) |
| df_rd_immadr_i | (Early) direct read address |
| df_rdimm_i | (Early) direct pickup |
| | (rafwd_rw_adr_i) or indirect |
| | register (rafwd_rw_adr_i) read |
| | address |
| df_rd_i | (Early) allowance of a read |
| | access operation |
| d2_wr_i | (Late) allowance of a write |
| | access operation |
| d2_wr_adr_i | (Late) write address |
| d2_wr_data_i | (Late) write data |
| d2_wr_adrimm_i | (Late) direct pick (d2_wr_adr_i) |
| | or indirect register |
| | (rafwd_rw_adr_i) write address |
| d2_wr_dataimm_i | (Late) direct pickup |
| | (d2_wr_data_i) or register |
| | (ra_rw_data_i) write data |
| ra_wr_data_i | (Late) register write data |
| OUTPUT SIGNAL: | |
| ra_iffwd_wr_data_o | Result of a read access operation |

The signals denoted as “early” in the table above are those signals which are valid when a memory access operation is initiated, while the signals denoted by “late” are those signals which are valid when the memory access operation has ended. The times of initiation and ending of a memory access operation are prescribed by the clock signal 100 or by the corresponding rising or falling clock edges, which represent reference times 104a, 104b (see FIG. 5).

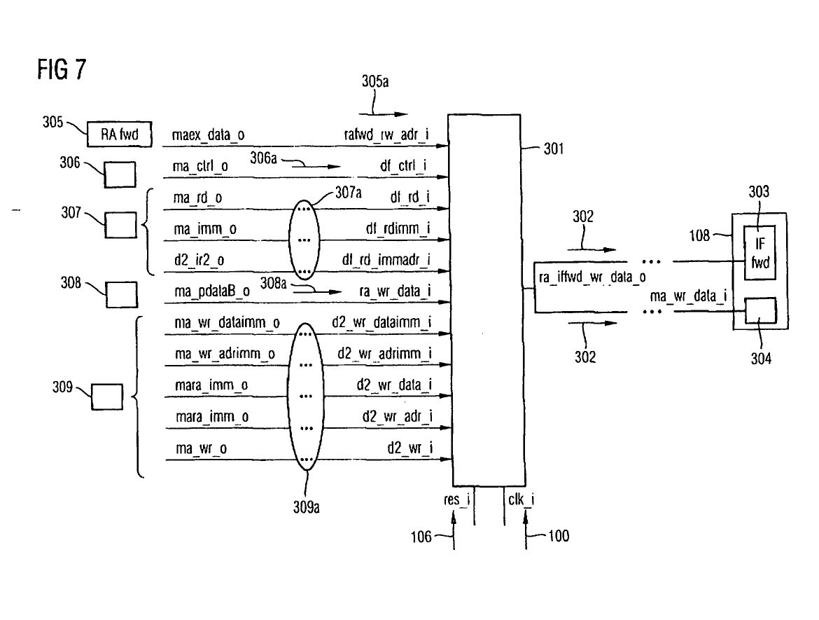

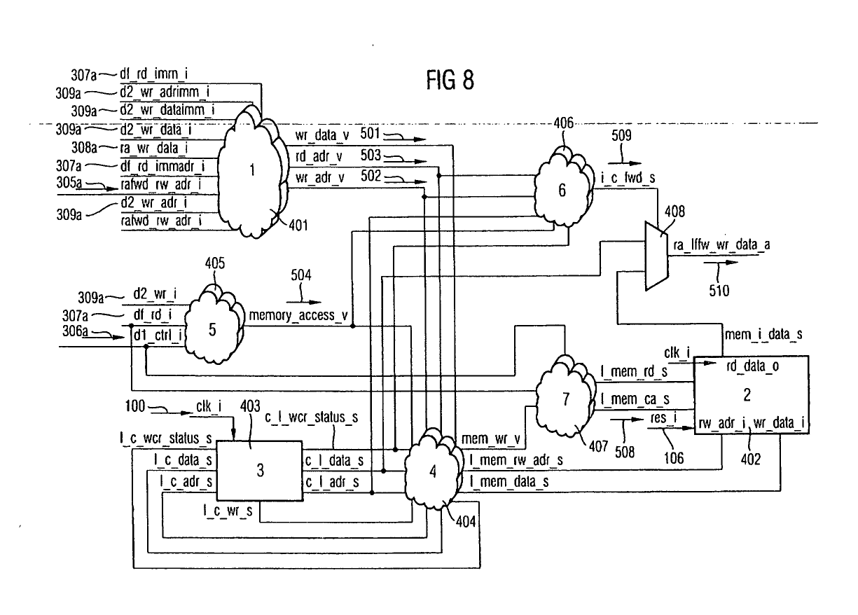

FIG. 7 shows a memory access unit 301 based on a preferred exemplary embodiment of the present invention in more detailed form with units for generating the input signals for the memory access unit 301 and with a data output unit 109. The units for generating input signals for the memory access unit 301 comprise a register addressing unit 305, a short instruction unit 306, a read control unit 307, a register access unit 308 and a write control unit 309.

The data output unit 108 comprises an output interface unit 303 and an output connection unit 304. The memory access unit 301 has a read/write address 305a (rafwd_rw_adr_i) supplied to it by the register addressing unit 305, as listed in table 1 above.

The short instruction unit 306 provides a short instruction signal 306a which is likewise supplied to the memory access unit 301.

A read control unit 307 generates a series of read instruction signals 307a, i.e. signals which are supplied to the memory access unit 301 as df_rd_i, df_rdimm_i and df_rd_immadr_i in line with table 1 above.

The register write control unit 308 provides a register write instruction signal 308a, i.e. a signal ra_wr_data_i is supplied to the memory access unit 301 as an input signal. In addition, the write control unit 309 is provided in order to supply the signals d2_wr_dataimm_i, d2_wr_adrimm_i, d2_wr_data_i, d2_wr_adr_i and d2_wr_i already listed in table 1 above as write instruction signals 309a to the memory access unit 301. As an output signal, the memory access unit 301 provides a read access output signal 302 (ra_iffwd_wr_data_o), which is supplied firstly to the output connection unit 304 and secondly to the output interface unit 303 of the data output unit 108.

As illustrated in the table above, the read and write signals are prescribed independently of one another such that the distance between read and write control signals is not committed to a single clock cycle.

A reset signal 106 is used to reset the memory access unit 301, while the clock signal 100 is likewise supplied to the memory access unit 301 as a time reference.

FIG. 8 shows the design of the memory access unit 301 in greater detail. Essentially, the memory access unit 301 comprises the function blocks 401-408, i.e. a read/write selection unit 401, a memory unit 402 for storing processed data, the data being able to be written to and read from the memory unit 402 on the basis of a write control signal and a read control signal, a write storage register 403, a random logic unit 404, a memory access type unit 405, a response detection unit 406, an allocation unit 407 and a combinational logic unit 408.

The text below explains the individual function blocks of the inventive memory access unit 301 and their input and output signals. It is also possible to see the interaction between the individual function blocks from FIG. 8, which likewise illustrates the connecting lines with the associated signals and their labels.

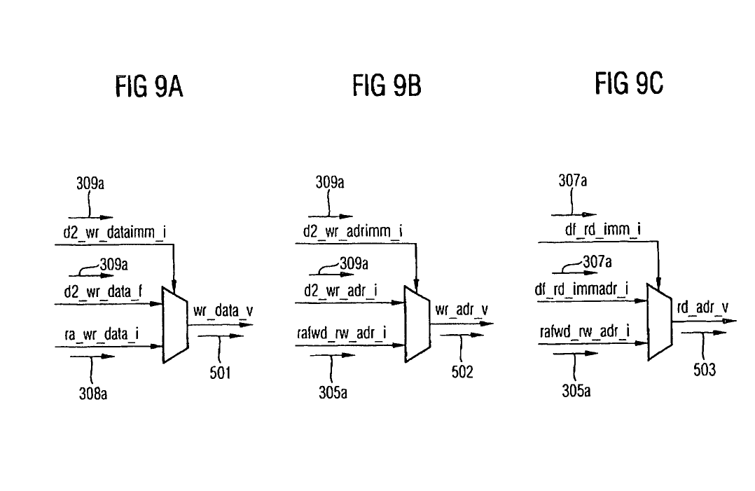

FIG. 9 shows the way in which the read/write selection unit 104 works in greater detail. As FIG. 9(a) shows, the read/write selection unit 401 essentially combines the write instruction signals 309(a) (see table 1) and the register write instruction signal 308a to form write data 501 (wr_data_v). These write data are supplied to the random logic unit 404.

In addition, the read/write selection unit 104 provides a memory write address 502 on the basis of the write instruction signals 309a and a read/write address 305a, as FIG. 9(b) shows. It is also possible to use the read/write selection unit 401 to generate a memory read address 503 on the basis of the read/write address 305a and read instruction signals 307a supplied to the read control unit 307.

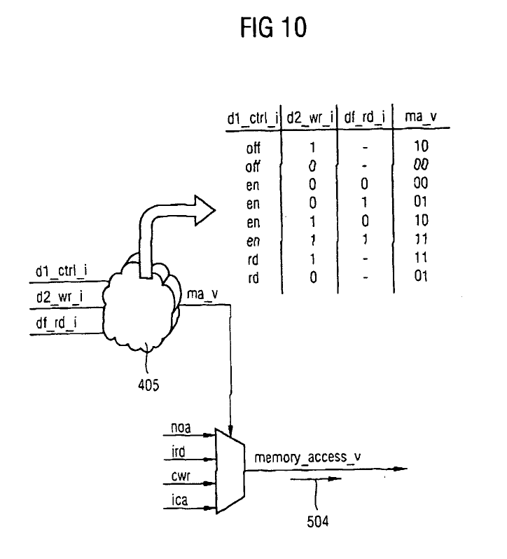

FIG. 10 shows a memory access type unit 405 in which a suitable memory access type is selected and is allocated to a signal memory_access_v. Such a memory access type signal 504 is output from the memory access type unit 405 and is supplied both to the random logic unit 404 and to the response detection unit 406.

The table illustrated at the top right of FIG. 10 illustrates combinational logic for the signals d1_ctrl_i, d2_wr_i, df_rd_i, defined in table 1, in order to obtain the memory access type signal 504. In line with the invention, in this context the signal d1_ctrl_i is an “early” signal which (i) is set to “OFF” when there is no memory access command, which (ii) is set to “ON” when there is a possible memory access command, and which (iii) is “rd” when there is a safe read access command.

It should be pointed out that “possible memory access command” means that there is either an early signal “df_rd_i” or a late write signal “d2_wr_i”. The values “off” and “rd” for the “d1_ctrl_i” signal are redundant and could be omitted.

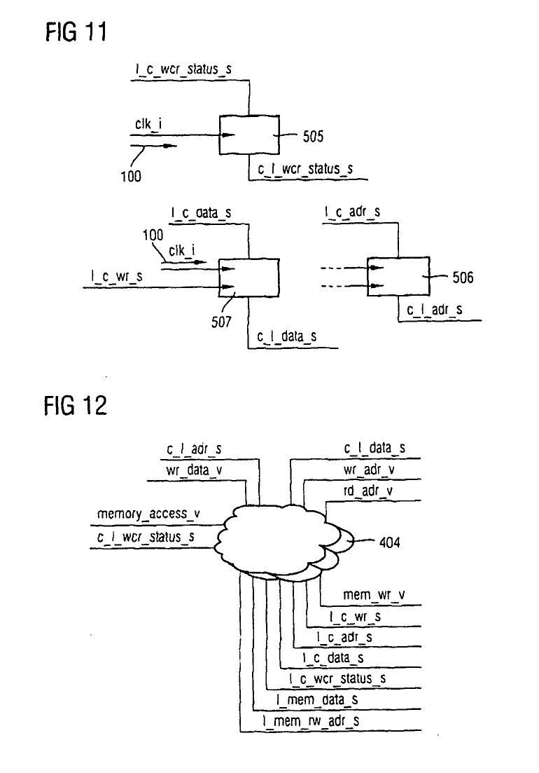

FIG. 11 shows the design of the write storage register 403 based on a preferred embodiment of the present invention. As FIG. 11 shows, the write storage register 403 essentially comprises a status register 505, an address register 506 and a data register 507.

All registers respectively have the clock signal 100 supplied to them in parallel.

Such a “write cache register” is necessary in order to buffer-store write data, a memory write address and a memory read address. The write data and address data in the registers 505, 506 and 507 are updated only when a write control signal 1_c_wr_s is active.

It should be pointed out that the data to be stored in the cache register are not limited to the data which are actually stored in the memory unit. The register may equally contain any control data referring thereto.

FIG. 12 shows a random logic unit 404 which performs no access, read access, write access or combined read and write access for the write storage register.

The random logic unit 404 performs no access when the memory access type signal 504 is “noa”.

No update takes place for the write storage register 403 when the write storage register 403 is full, the data which are stored in its data and address registers being written to the data store such that the write storage register 403 becomes empty.

When the write storage register 403 is empty, no memory access is performed and the write storage register 403 remains empty.

Read access takes place when the memory access type signal is “ird”. In this context, the write storage register 403 is not updated and the read address (rd_adr_v) is routed to the data store. In addition, the random logic unit 404 performs write access when the memory access signal 504 is “cwr”.

When the write storage register 403 is full, data from the write storage register 403 are written to the data store. When the write storage register 403 is empty, the external data are written directly to the data store, and the write storage register 403 is not updated and remains empty.

In addition, the random logic unit 404 performs a combined read and write access operation when the memory access type signal 504 is “ica”. In this context, the write storage register 403 is always empty.

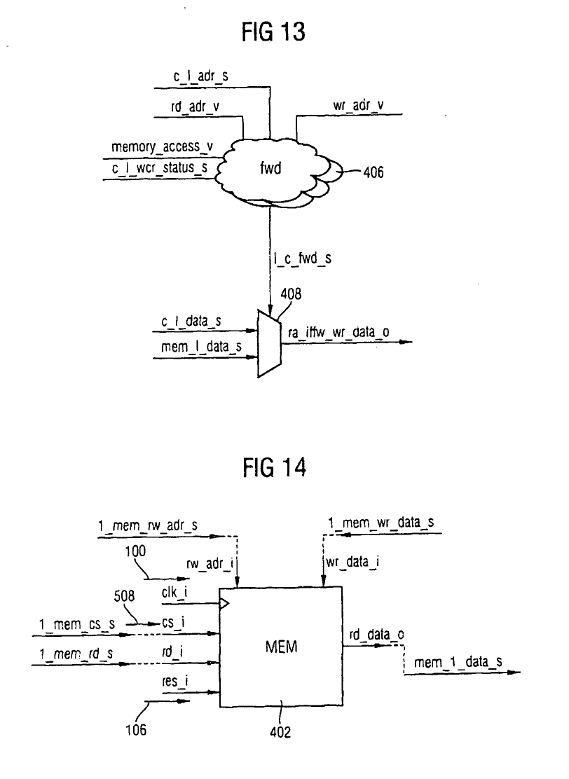

As FIG. 13 shows, the memory access unit 301 also has a response detection unit 406 and a combinational logic unit 408. The response detection unit 406 generates a response signal 509 on the basis of the memory access type signal 504. The response signal 509 is supplied to the combinational logic unit 408, which contains memory data from the memory unit 402. The combinational logic unit 408 provides the read access output signal 302 as the output signal from the data processing apparatus.

As FIG. 14 shows, the memory unit 402 receives not only the clock signal 100 but also the chip select signal 508 and the reset signal 106. The output signal from the memory unit 402 (mem_1_data_s) is supplied to the combinational logic 408, as already mentioned above with reference to FIG. 13.

Table 2 below shows the associations which an allocation unit 407 in the memory access unit 301 provides between the signals d1_ctrl_i, 1_mem_cs_s and m_mem_rd_s.

TABLE 2

| d1_ctrl_i | l_mem_cs_s | l_mem_rd_s |
|---|---|---|
| Off | mem_wr_v | 0 |
| En | df_rd_i or | df_rd_i |
| | mem_wr_v | |
| Rd | 1 | 1 |

The signals 1_mem_rd_s and 1_mem_cs_s (i.e. the chip select signal) are supplied to the memory unit 403.

With regard to the conventional method for processing data, reference is made to the introduction to the description for the timing diagram shown in FIG. 1.

Although the present invention has been described above using preferred exemplary embodiments, it is not limited thereto but rather may be modified multifariously.

The invention is also not limited to the application options cited.

1. Data processing apparatus, having:
a) a data input unit for inputting data;
b) at least one processor unit for carrying out data processing steps for the input data;
c) at least one memory unit for storing processed data, the data being able to be written to and read from the memory unit on the basis of a write control signal and a read control signal; and
d) a data output unit for outputting stored data, wherein the write control signal can be prescribed independently of the timing of the read control signal.

2. Apparatus according to claim 1, wherein the write control signal and the read control signal are provided on the basis of the timing of a clock signal which is supplied to the data processing apparatus.

3. Apparatus according to claim 1, wherein the data processing steps carried out in the at least one processor unit for the input data comprise mathematical operations.

4. Apparatus according to claim 1, wherein the at least one memory unit is provided for storing processed data in a memory access unit which provides either a read/write control signal having a fixed coupling between the timing of the write control signal and that of the read control signal or a write control signal which is delayed in comparison with the read control signal.

5. Apparatus according to claim 4, wherein a register addressing unit is provided which supplies read/write addresses to the memory access unit.

6. Apparatus according to claim 4, wherein a short instruction unit is provided which supplies short instruction signals to the memory access unit.

7. Apparatus according to claim 4, wherein a read control unit is provided which supplies read instruction signals to the memory access unit.

8. Apparatus according to claim 4, wherein a register write control unit is provided which supplies register write instruction signals to the memory access unit.

9. Apparatus according to claim 4, wherein a write control unit is provided which supplies write instruction signals to the memory access unit.

10. Apparatus according to claim 4, wherein the memory access unit also has a read/write selection unit which can select write data, memory write addresses and/or memory read addresses.

11. Apparatus according to claim 4, wherein the memory access unit also has a write storage register which provides buffer storage of write data, memory write addresses and of a register status.

12. Apparatus according to claim 4, wherein the memory access unit also has a random logic unit which performs the options of no access, read access, write access or combined read and write access for the write storage register.

13. Apparatus according to claim 4, wherein the memory access unit also has a memory access type unit which outputs a memory access type signal on the basis of at least one short instruction signal, at least one read instruction signal and/or at least one write instruction signal.

14. Apparatus according to claim 4, wherein the memory access unit also has a response detection unit which outputs a response signal.

15. Apparatus according to claim 4, wherein the memory access unit also has an allocation unit which supplies a chip select signal to the memory unit.

16. Apparatus according to claim 4, wherein the memory access unit also has a combinational logic unit which outputs a read access output signal on the basis of the response signal supplied by the response detection unit.

17. Method for processing data, having the following steps:
a) inputting data using a data input unit;
b) carrying out data processing steps for the input data using at least one processor unit;
c) storing the processed data in at least one memory unit, the data being able to be written to and read from the memory unit on the basis of a write control signal and a read control signal; and
d) outputting the stored data using a data output unit, wherein the write control signal and the read control signal are prescribed independently of one another's timing.

18. Method according to claim 17, wherein the write control signal and the read control signal are prescribed on the basis of the timing of a clock signal which is supplied to the data processing apparatus.

19. Method according to claim 17, wherein mathematical operations are carried out in the at least one processor unit for the input data as data processing steps.

20. Method according to claim 17, wherein the at least one memory unit is provided for storing processed data in a memory access unit which outputs either a read/write control signal having a fixed coupling between the timing of the write control signal and that of the read control signal or a write control signal which is delayed in comparison with the read control signal.

21. Method according to claim 20, wherein read/write addresses are supplied to the memory access unit using a register addressing unit.

22. Method according to claim 20, wherein short instruction signals are supplied to the memory access unit using a short instruction unit.

23. Method according to claim 20, wherein read instruction signals are supplied to the memory access unit using a read control unit.

24. Method according to claim 20, wherein register write instruction signals are supplied to the memory access unit using a register write control unit.

25. Method according to claim 20, wherein write instruction signals are supplied to the memory access unit using a write control unit.

26. Method according to claim 20, wherein write data, memory write addresses and/or memory read addresses are selected using a read/write selection unit in the memory access unit.

27. Method according to claim 20, wherein write data, memory write addresses and a register status are buffer-stored using a write storage register in the memory access unit.

28. Method according to claim 20 wherein a random logic unit in the memory access unit performs the options of no access, read access, write access or combined read and write access for the write storage register.

29. Method according to claim 20, wherein a memory access type signal is output using a memory access type unit in the memory access unit on the basis of at least one short instruction signal, at least one read instruction signal and/or at least one write instruction signal.

30. Method according to claim 20, wherein a response signal is output by a response detection unit in the memory access unit.

31. Method according to claim 20, wherein the memory unit is provided with a chip select signal using an allocation unit in the memory access unit.

32. Method according to claim 20, wherein a read access output signal is output using a combinational logic unit in the memory access unit on the basis of the response signal supplied by the response detection unit.
